(19) United States
(12) Patent Application Publication
(10) Pub. No.: US 2019/0142688 A1
(43) Pub. Date: May 16, 2019

(54) Exercise and Massage Device

(71) Applicant: Emerge Fitness Ltd., Stroud (GB)

(72) Inventor: Jesse DARLEY, Madison, WI (US)

(21) Appl. No.: 15/811,976

(22) Filed: Nov. 14, 2017

(51) Int. Cl. A61H 15/00; A63B 23/02; A63B 22/20; A63B 21/00; A61H 1/00

(52) U.S. Cl. CPC A61H 15/0092; A63B 23/0205; A63B 22/20; A63B 21/4035; A63B 21/4049; A63B 21/0004; A63B 2213/00; A61H 2015/0014; A61H 2201/0157; A61H 2201/1253; A61H 2201/1695; A63B 2209/00; A63B 2208/0295; A61H 1/008

(57) ABSTRACT

An exercise and massage device that includes a first cylindrical member having two end portions and an interposing central portion which is rotatable relative to each of the end portions, a second cylindrical member having a central bore adapted to receive the first cylindrical member; and a releasable catch member adapted to laterally constrain the second cylindrical member at a central region of the first cylindrical member while the two end portions are exposed such that the exercise and massage device is operable as an abdominal exercise device. The first cylindrical member is operable as a first muscle massage device.

Embodiments relate to exercise equipment and muscle manipulation equipment. In particular, but not exclusively, embodiments relates to abdominal exercise equipment and muscle massage equipment.

### BACKGROUND

It is known to provide various forms of exercise equipment. This includes abdominal rollers. These devices typically comprise a relatively thin wheel and a handle extending from the axis of the wheel at each side of the wheel. The wheel is rotatable relative to the handles. Typically, users position themselves on all fours and place a hand on each handle. Each of the actions of rolling the device away from and then towards the user exercises the abdominal muscles. To focus the exercising on the abdominal muscles and not on other muscles such as upper body muscles, the user's hands should not be too far apart. Therefore, the wheel or roller is relatively thin, and the distance between each end of the handles is typically less than 0.5 m.

It is also known to provide various forms of equipment for massaging or manipulating muscles. Hereinafter, the term “massaging” will be used. It is intended to cover the treatment of muscle pain, strains, stress, spasm, tension, cramping, (myofascial) trigger points, preventing muscle fatigue, and inhibiting overactive muscles.

One such device is a foam roller. This comprises a foam cylinder having a typical diameter of 0.15 m and a typical length of 0.3 m (longer rollers are available for treating back muscles). The density of the foam roller varies. A user rolls the foam roller under each muscle group until a tender area is found, and then maintains pressure on the tender area for around 30 to 60 seconds. The rolling is achieved using the weight of the user's body part on the roller (and the friction between them) and the user's lateral motion. Therefore, no handle or the like is required. The foam roller is generally used for larger muscle groups.

Similarly, massage sticks are used for massaging muscles. The massage stick is typically about 0.25 m in diameter and 0.5 m in length. It comprises a central cylinder and a handle at each end of the cylinder. The cylinder rotates relative to the handles. The cylinder has a number of nodules or protuberances on its outer surface.

Conventionally, each of the three above-mentioned devices are provided separately.

### SUMMARY OF THE INVENTION

In accordance with embodiments, it is desirable to provide a single device which may be used for both exercising and muscle massage.

In accordance with embodiments, an exercise and massage device may comprise at least one of the following: a first cylindrical member comprising two end portions and an interposing central portion which is rotatable relative to each of the end portions, wherein the first cylindrical member is operable as a first muscle massage device; a second cylindrical member having a central bore adapted to receive the first cylindrical member; and a releasable catch member adapted to laterally constrain the second cylindrical member at a central region of the first cylindrical member while the two end portions are exposed such that the exercise and massage device is operable as at least one of a second muscle massage device and an abdominal exercise device.

Alternatively or additionally, the first cylindrical member has a length which is around 0.4 m.

Alternatively or additionally, the first cylindrical member has a maximum outer diameter which is around 0.05 m.

Alternatively or additionally, each end portion of the first cylindrical member has a length which is around 0.1 m.

Alternatively or additionally, the second cylindrical member has a suitable length and outer diameter such that the second cylindrical member is operable as a foam roller device.

Alternatively or additionally, the second cylindrical member has a length which is around 0.2 m. Optionally, the second cylindrical member has an outer diameter which is around 0.15 m.

Alternatively or additionally, the second cylindrical member includes a larger diameter section at each end of the second cylindrical member.

Alternatively or additionally, the catch member adapted to rotatably constrain the second cylindrical member relative to the central portion of the first cylindrical member. In such case, the second cylindrical member and the central portion together rotate relative to the two end portions.

Alternatively or additionally, the catch member is adapted to laterally constrain the second cylindrical member but allow rotation of the second cylindrical member relative to the first cylindrical member.

Alternatively or additionally, the second cylindrical member is operable as a second muscle massaging device. Optionally, the second cylindrical member is operable as a second muscle massaging device by using the two exposed end portions.

Alternatively or additionally, the second cylindrical member is operable as a foam roller device. Optionally, the second cylindrical member is operable as a foam roller device whether or not the first cylindrical member is within the central bore of the second cylindrical member.

Alternatively or additionally, the first cylindrical member includes a plurality of nodules on the outer surface of the central portion.

Alternatively or additionally, the central bore is sized to accommodate the central portion and nodules.

Alternatively or additionally, the central bore includes a guide device for assisting insertion of the first cylindrical member.

Alternatively or additionally, at least the outer surface of the central portion is formed from a resilient material. Optionally, at least the outer surface of the central portion is formed from a foam material. Optionally, at least the outer surface of the central portion is formed from a medium density foam.

Alternatively or additionally, the nodules may be formed from a resilient material.

Alternatively or additionally, at least the outer surface of the second cylindrical member is formed from a resilient material. Optionally, at least the outer surface of the second cylindrical member is formed from a foam material. Optionally, at least the outer surface of the second cylindrical member is formed from a medium density foam.

Alternatively or additionally, the releasable catch member comprises a ratchet lever.

Alternatively or additionally, the exercise and massage device includes a stop member for preventing further insertion of the first cylindrical member within the central bore of the second cylindrical member when the second cylindrical member is at the central region of the first cylindrical member.

Alternatively or additionally, the stop member comprises a first ramp portion provided at the first cylindrical member which progressively increases in diameter in the inserting direction.

Alternatively or additionally, the catch member is suitably configured or positioned relative to the stop member such that, when the second cylindrical member is at the central region of the first cylindrical member, the catch member automatically engages to laterally constrain the second cylindrical member.

Alternatively or additionally, the catch is openable by a second ramp portion of the first cylindrical member. Optionally, the second ramp portion is adapted to move a resilient portion of the catch during insertion. Optionally, the resilient portion of the catch is adapted to resiliently close when the first cylindrical member has been inserted to the desired position.

In accordance with embodiments, a method of exercising and massaging a muscle using a single device may comprise at least one of the following: providing a first cylindrical member comprising two end portions and an interposing central portion which is rotatable relative to each of the end portions; utilizing the first cylindrical member as a first muscle massage device; providing a second cylindrical member having a central bore adapted to receive the first cylindrical member; inserting the first cylindrical member within the central bore such that the second cylindrical member is at a central region of the first cylindrical member while the two end portions are exposed; laterally constraining the second cylindrical member relative to the first cylindrical member; utilizing the combined first cylindrical member and second cylindrical member as at least one of a second muscle massage device and an abdominal exercise device.

Alternatively or additionally, the method includes providing a releasable catch member to laterally constraining the second cylindrical member relative to the first cylindrical member.

Alternatively or additionally, the method includes providing a stop member which prevents further insertion of the first cylindrical member within the central bore.

Alternatively or additionally, the method includes utilising the second cylindrical member as a foam roller device.

Alternatively or additionally, the method includes utilising the combined first cylindrical member and second cylindrical member as a foam roller device.

### BRIEF DESCRIPTION OF THE DRAWINGS

The summary of embodiments, as well as the detailed description is better understood when read in conjunction with the accompanying drawings that illustrate one or more possible embodiments of embodiments, in which:

FIG. 1 illustrates a perspective view of a massage stick component, in accordance with embodiments.

FIG. 2 illustrates a perspective view of a foam roller component, in accordance with embodiments.

FIG. 3 is a perspective view of the complete apparatus, in accordance with embodiments.

### DETAILED DESCRIPTION

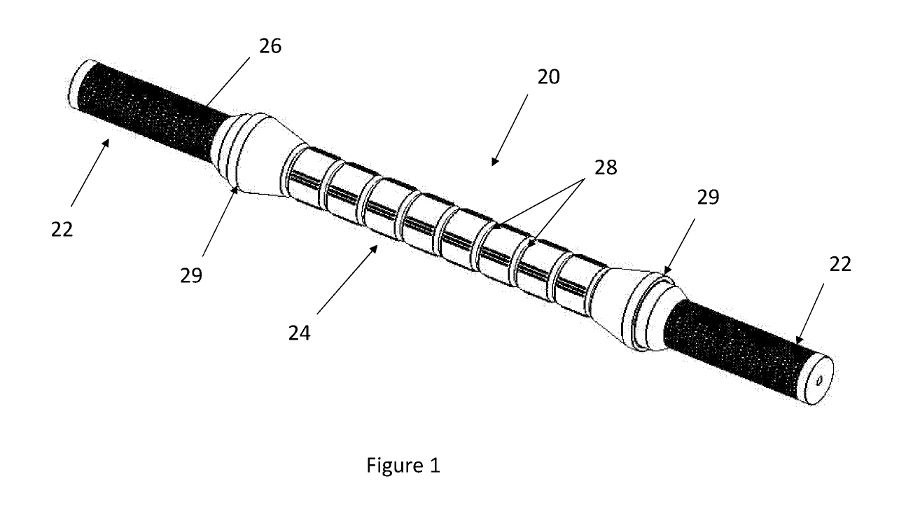

FIG. 1 illustrates a component of an exercise and massage device 10. The component comprises a first cylindrical member 20 which has two end portions 22 and an interposing central portion 24. The central portion 24 is rotatable relative to each end portion 22.

The first cylindrical member 20 has a total length which is around 0.4 m. Each end portion 22 of the first cylindrical member 20 has a length which is around 0.1 m and the central portion 24 has a length of around 0.2 m. The maximum outer diameter of the first cylindrical member is around 0.05 m. Each end portion 22 is provided with a gripping surface 26.

A number or plurality of nodules 28 are provided on the outer surface of the central portion 24. These nodules 28 are formed from a firm but resilient material such as a medium density foam. Therefore, the first cylindrical member 20 is suitably dimensioned and configured such that it may be operated as a massage stick. This is typically used to massage smaller muscle groups.

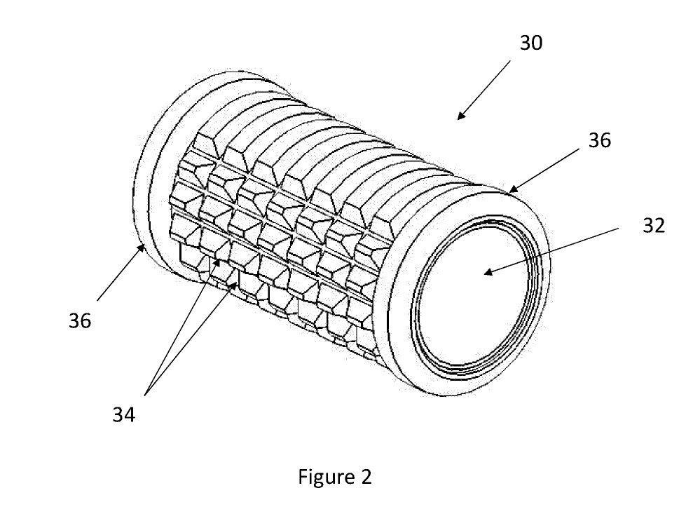

As illustrated in FIG. 2, the exercise and massage device 10 also includes a second cylindrical member 30. This has a central bore 32 through which the first cylindrical member 20 may be inserted. The central bore 32 is suitably sized to accommodate the central portion 24 and the nodules 28. The central bore 32 includes guide device (not illustrated) to assist insertion of the first cylindrical member 20. The second cylindrical member 30 has a length which is about 0.2 m and an outer diameter which is around 0.15 m. The diameter of the central bore 32 is about 0.07 m.

Nodules 34 are also provided on the outer surface of the second cylindrical member 30. These nodules 34 are again formed from a material such as a medium density foam. Therefore, the second cylindrical member 30 has a suitable length and outer diameter and is suitably configured such that it may be used as a foam roller. The second cylindrical member 30 may be used in this way regardless of whether or not the first cylindrical member 20 is within the central bore 32 of the second cylindrical member 30.

The second cylindrical member 30 is also operable as a second (larger diameter) muscle massaging device when the first cylindrical member 20 is within the central bore 32. In this case, the user uses the two exposed end portions as handles. The advantage of this is that it is less aggressive than using body weight (to laterally move the foam roller) and it is less aggressive than the massage stick due to its larger diameter.

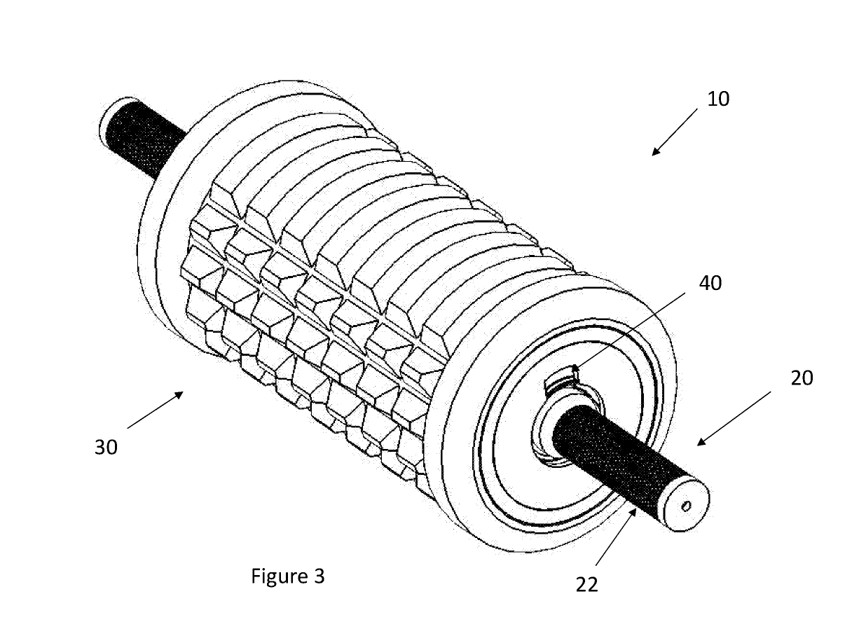

FIG. 3 illustrates a complete exercise and massage device 10. The first cylindrical member 20 has been inserted for receipt within the bore 32 of the second cylindrical member 30 until the second cylindrical member 30 is located around a central region of the first cylindrical member 20. Due to the relative lengths of the two components, the two end portions 22 are exposed.

The exercise and massage device 10 includes a stop 29 for preventing further insertion of the first cylindrical member 20. This is in the form of a ramp portion 29 which progressively increases in diameter in the inserting direction. When the first cylindrical member 20 has been inserted to the desired position, the ramp portion 29 abuts an internal portion of the central bore 32.

A releasable catch 40 engages when the first cylindrical member 20 reaches this position. This prevents extraction of the first cylindrical member 20 from the bore 32 of the second cylindrical member 30 unless the catch 40 is released. The catch 40 is opened when a second ramp portion 29 of the first cylindrical member 20 moves a resilient portion of the catch during insertion. When the first cylindrical member 20 has been inserted to the desired position, the ramp portion 29 passes the catch which then resiliently closes to prevent extraction.

Since both the stop and the catch operating member are provided by the ramp portion 29, the first cylindrical member 20 may be symmetrical about a mid-point along the length of the first cylindrical member 20.

The catch 40 laterally constrains the second cylindrical member 30 at the central region of the first cylindrical member 20. However, the second cylindrical member 30 is still free to rotate relative to the first cylindrical member 20. Therefore, the second cylindrical member 30 is rotatable relative to the end portions 22 of the first cylindrical member 20. Therefore, the exercise and massage device 10 may be operated as an abdominal exercise device.

The second cylindrical member 30 includes a larger diameter section 36 at each end of the second cylindrical member 30. These allow the roller to move smoothly during abdominal rolling while still maintaining a large section with nodules between the two end sections 36 for foam rolling and massaging.

In an alternative embodiment, the catch 40 is adapted to also rotatably constrain the second cylindrical member 30 relative to the central portion 24 of the first cylindrical member 20. However, since the central portion 24 may rotate relative to the end portions 22, the second cylindrical member 30 and the central portion 24 may rotate together relative to the two end portions 22. Therefore, the exercise and massage device 10 may still be operated as an abdominal exercise device.

If a user wishes to separate the first cylindrical member 20 and the second cylindrical member 30, a user may readily release the catch 40 by simply pressing on a lever with one finger.

The device 10 may include end caps for containing the first cylindrical member 20 inside the second cylindrical member 30. One of these may be fixed and a part of the second cylindrical member 30. The other may be removable, to allow insertion of the first cylindrical member 20, and re-attachable.

In use, the user may use the first cylindrical member 20 as a massage stick. The user may then wish to perform abdominal exercises. The user simply slides the second cylindrical member 30 over the first cylindrical member 20. When the second cylindrical member 30 reaches the correct position, it will contact the stop which will prevent further insertion. Also, the catch 40 will automatically engage to prevent the second cylindrical member 30 moving laterally in the opposite direction.

The exercise and massage device 10 may now be used as an abdominal exercise device. The lengths of the first cylindrical member 20 and the second cylindrical member 30 are suitable such that the distance between each end of the end portions 22 is less than 0.5 m.

The device 10 may also be used as a foam roller. Unlike the wheel of conventional abdominal exercise devices, the second cylindrical member 30 has sufficient length, and is made from a suitable material, for this purpose.

Therefore, the exercise and massage device 10 of the invention may readily serve three different purposes. It should be noted that fastening or complicated assembly (or unfastening and disassembly) are required to convert the device 10 from one configuration to another. Conversion from the massage stick to the abdominal exercise device or foam roller requires only the single step of sliding the second cylindrical member 30 over the first cylindrical member 20. Conversion from the abdominal exercise device or foam roller to the massage stick requires only the single step of releasing the catch 40 while simultaneously extracting the first cylindrical member 20 from the second cylindrical member 30.

Various modifications and improvements may be made to the above without departing from the scope of the invention.

The terms “coupled,” “attached,” or “connected” may be used herein to refer to any type of relationship, direct or indirect, between the components in question, and may apply to electrical, mechanical, fluid, optical, electromagnetic, electromechanical or other connections. In addition, the terms “first,” “second,” etc. are used herein only to facilitate discussion, and carry no particular temporal or chronological significance unless otherwise indicated.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

What is claimed is:

1. An exercise and massage apparatus, comprising:
a first cylindrical member having two end portions and an interposing central portion which is rotatable relative to each of the end portions, wherein the first cylindrical member is operable as a first muscle massage device;
a second cylindrical member having a central bore adapted to receive the first cylindrical member; and
a releasable catch member adapted to laterally constrain the second cylindrical member at a central region of the first cylindrical member while the two end portions of the first cylindrical member are exposed to permit the exercise and massage apparatus to be operable as at least one of a second muscle massage device and an abdominal exercise device.

2. The exercise and massage apparatus of claim 1, wherein the second cylindrical member has an outer diameter to enable the second cylindrical member to be operable as a foam roller apparatus.

3. The exercise and massage apparatus of claim 1, wherein the catch member is configured to rotatably constrain the second cylindrical member relative to the central portion of the first cylindrical member.

4. The exercise and massage apparatus of claim 1, wherein the catch member is configured to laterally constrain the second cylindrical member but allow rotation of the second cylindrical member relative to the first cylindrical member.

5. The exercise and massage apparatus of claim 1, wherein the second cylindrical member is operable as a foam roller device.

6. The exercise and massage apparatus of claim 1, wherein the second cylindrical member is operable as a foam roller device whether or not the first cylindrical member is within the central bore of the second cylindrical member.

7. The exercise and massage apparatus of claim 1, wherein the first cylindrical member includes a plurality of nodules on an outer surface of the central portion.

8. The exercise and massage apparatus of claim 7, wherein the central bore is sized to accommodate the central portion and the nodules.

9. The exercise and massage apparatus of claim 7, wherein the nodules are formed from a resilient material.

10. The exercise and massage apparatus of claim 1, wherein at least an outer surface of the central portion is formed from a resilient material.

11. The exercise and massage apparatus of claim 1, wherein at least an outer surface of the second cylindrical member is formed from a resilient material.

12. The exercise and massage apparatus of claim 1, further comprising a stop member configured to prevent further insertion of the first cylindrical member within the central bore of the second cylindrical member when the second cylindrical member is at the central region of the first cylindrical member.

13. The exercise and massage apparatus of claim 12, wherein the catch member is positioned relative to the stop member such that, when the second cylindrical member is at the central region of the first cylindrical member, the catch member automatically engages to laterally constrain the second cylindrical member.

14. The exercise and massage apparatus of claim 12, wherein the stop member comprises a first ramp portion provided at the first cylindrical member which progressively increases in diameter in the inserting direction.

15. The exercise and massage apparatus of claim 1, wherein the exposed end portions of the second cylindrical member are configured to permit the second cylindrical member to be operable as a second muscle massaging device.

16. The exercise and massage apparatus of claim 1, wherein the central bore includes a guide member configured to assist insertion of the first cylindrical member.

17. The exercise and massage apparatus of claim 1, wherein the second cylindrical member includes a larger diameter section at each end of the second cylindrical member.

18. The exercise and massage apparatus of claim 1, wherein the first cylindrical member includes a ramp portion configured to open the catch member.

19. The exercise and massage apparatus of claim 18, wherein the ramp portion is configured to move a resilient portion of the catch member during insertion.

20. A device as claimed in claim 1, wherein the resilient portion of the catch member is configured to resiliently close upon insertion of the first cylindrical member to a desired position.
